(19) United States
(12) Patent Application Publication
(10) Pub. No.: US 2010/0245373 A1
(43) Pub. Date: Sep. 30, 2010

(54) METHOD AND SOFTWARE OF DRAWING VECTOR-ORIENTED GRAPHIC FOR LASER PROJECTOR, AND A LASER PROJECTOR SYSTEM

(75) Inventors: Osama Halabi, Iwate (JP); Norishige Chiba, Iwate (JP)

Correspondence Address: YOUNG & THOMPSON, 209 Madison Street, Suite 500, Alexandria, VA, 22314, US

(73) Assignee: INCORPORATED NATIONAL UNIVERSITY IWATE UNIVERSITY, Morioka-shi, Iwate (JP)

(21) Appl. No.: 12/739,218

(22) PCT Filed: Oct. 29, 2008
(86) PCT No.: PCT/JP2008/070159

§ 371 Date: May 12, 2010

Related U.S. Application Data
(60) Provisional application No. 60/983,583, filed on Oct. 30, 2007.

(51) Int. Cl. G09G 5/00; G02B 26/10

(52) U.S. Cl. 345/581; 359/200.7

(57) ABSTRACT

The laser projector system draws vector-oriented graphic by scanning laser beam with the X-Y scanner, and comprises: a laser source (201) for projecting laser beam; a galvanometer scanner (202) for scanning laser beam with the X-Y mirror (203) to freely control the direction of laser beam; a scanner amp (205) for controlling projection output of laser beam; a scanner controller (204) for controlling the galvanometer scanner and the scanner amp; and a computer (207) connected to the scanner controller (204).

### TECHNICAL FIELD

The present invention relates to technologies for drawing vector-oriented graphic for laser projector.

### BACKGROUND OF THE INVENTION

In the early seventies, a laser beam and a pair of scanners were used to create a projection of graphic imagery. Each scanner is a small high-speed precision motor-driven mirror that deflects single or multiple laser beams to trace an image several times per second. The mirrors deflect each point of the image at such a high rate of speed that they create the illusion of a solid line [1]. These little mirrors can use any surface as a screen, including nonsolid surfaces like smoke or mist. In the early eighties this technique finds it way to the music concert where some artists experimented with various caustic patterns in an attempt to define light as a form in its own right, much the way a composer defines the sound. Then, the laser show as an art form with a little help from the technology of laser medium was born [2].

Conventional projection methods (raster display) have limits to size and distance. The light of even the most powerful motion picture projector diminishes rapidly in direct proportion to its distance from the projection surface. In contract, laser display, which is a vector display, can project an image to a far greater distance due to the nature of coherent light. Laser graphics can be seen on just about any relatively smooth, relatively light surface. You can use conventional projection screens, inflatable screens, buildings and even mountains, which makes laser projection a unique and powerful projection medium.

Laser graphics can display a client's logo, animated their product, tell a story, or simple entertain. Because of technology requirements, these images are cartoon-like outlines, without any interior fill of detail. This can be a limitation, but it also helps make laser graphics shows very different and attention getting, compared with familiar video images. On the contrast, the computer's ability to display images of ever-increasing complexity gives rise to a new problem: communicating this complex information in a comprehensible and effective manner. In order to communicate truly complex information, some form of visual abstraction is required [3]. In Non-Photorealistic rendering (NPR) images are instead judged by how effectively they communicate. NPR involves stylization and communication, usually driven by human perception. Knowledge and techniques long used by artists are now being applied to computer graphics to emphasize specific features of a scene, and omit extraneous information to give rise to a new field. These features make laser graphics a unique and a powerful means to convey information effectively through different projection mean [4].

There are many laser displays in the market, which can be roughly divided into two categories: laser display for laser shows and entertainment, there are many companies who produce such laser projection systems, a quick search on the web will bring up dozens of such systems. This type of display concerns mostly about the speed and providing full colors. The second category is laser projection systems for industrial application where accuracy is an important issue. Applications for such type of laser projection could be component placement, structural assembly, edge trimming, and viewing invisible sub-structure or hidden components in many manufacturing processes [5].

The companies who are producing laser projection systems that specifically used for beams show or for projecting imagery (graphics show) have agreed on ILDA test pattern for tuning their laser projectors [6]. The procedure to tune a laser projector using this pattern is well known for any laserist and laser hobbyist, which can be found on the Internet [7]. It is hardware tuning that can be done once by the company or the time when finish building a laser projector and that it, there is no need to be conducted every time. This tuning procedure involves many steps in which we need to alter variable resistances or jumpers on the circuit board (hardware tuning). Meanwhile, the companies, which produce scanners and galvanometers targeting industrial applications, are using more accurate and precise scanners. They apply different test patterns for tuning, each company has it is own secretive tuning pattern.

### REFERENCES

[1] J. D. Foley and A. V. Darn, Fundamentals of Interactive Computer Graphics, Addison-Wesley, 1984.
[2] J. Collinc and D. Tucker, “Laser Graphics and Animation”, BYTE, 9(10), 1984, pp. 177-184.
[3] G. Winkenbach and D. Salesin, “Computer-Generated Pen-and-Ink Illustration”, Proceedings SIGGRAPH 94, ACM Press/ACM SIGGRAPH, 1994, pp. 91-100.
[4] B. Gooch and A. Gooch, Non-Photorealistic Rendering, A K Peters, Ltd., 2001.
[5] Laser projection technologies, Inc. http://www.lptcorp.com/index.htm. Retrieved in April 2007.
[6] Pangolin, “ILDA Test Pattern”, http://www.pangolin.com/ILDAtest.html, Retrieved in April 2007.
[7] B. Benner and P. Murphy, “How to tune to the ILDA test pattern”. http://www.laserfx.com/Backstage.LaserFX.com/Systems/Scanningl.html, Retrieved in April 2007.
[8] GSI Lumonics, “Optical Scanners and Controllers”, http://www.gsig.com/, Retrieved in April 2007.
[9] Coherent, “Coherent Lasers”, http://www.coherent.com/, retrieved in April 2007.

### DISCLOSURE OF THE INVENTION

### Problem to be Solved by the Invention

The main concern of this research is how to project correctly a graphic on different laser projectors tuned to different testing patterns. If we used scanners that were tuned to unknown test pattern then we need to tune our data to get it projected correctly. As a result, when we make a program to show graphics on a laser projector and then try to play this data on different projectors, the possibility to get the same result is not always guaranteed, even in the case where both projectors were tuned to the same test pattern. This is because the scanning speed and blanking is different from projector to projector • this issue will be investigated extensively though out this paper. The case would be worse if the laser projector were tuned using different test patterns.

This paper presents a specific approach to be able to project vector data on any laser projector by fine tuning each vector data parameter to match exactly the delays exist in the projector's hardware. This is achieved through setting up simple tests that would enable us to exactly define the drawing time delay and blanking time that should be applied to each vector data to achieve correct projection. Moreover, set an approach on how to measure a laser projector practical speed as it always differ from the ideal speed that usually stated by the manufacture in the catalog. This is an important issue as there is no specific way to measure exactly the working speed for a laser projector. Also, we present a new approach for normalizing the intensity of the vector data (get same brightness for different vectors length) based on the speed concept that can be applicable for real time calculation. The currently used method depends on calculating each vector delay from the FPS (Frame rate) so one frame of data should be prepared before being able to set the drawing time delay for each vector data. Using the speed concept we need not to wait the next vector data to arrive as you we set the time delay for each vector on fly. FIG. 1 gives an idea of the result of the tuning approach by showing four different projection of the same image for different tuning setting to show how the data has be tuned to be projected correctly on a projector that is tuned to unknown test pattern.

### Means to Solve the Problem

To achieve the above target, the invention described in Claim 1 is a method of drawing vector-oriented graphic for laser projector, which draws vector-oriented graphic by scanning laser beam with the X-Y scanner, wherein a method to tune scanning speed, delay time, and blanking time is included, comprising: transmitting one vector-data, for drawing vector-oriented graphic, to a X-Y scanner one by one; controlling the scanning speed of each vector-data; calculating the delay time and the blanking time corresponding to the scanning speed of each vector-data; deciding appropriate timing to compensate the above-mentioned delay time when the command for transmitting vector-data is issued; and deciding appropriate timing to compensate the above-mentioned blanking time when the command for switching off/on the laser for blanked line segments is issued.

The invention described in Claim 2 is the method of drawing vector-oriented graphic for laser projector of claim 1, wherein parameters of the scanning speed, the scanning angle, the delay time, and the blanking time are included to achieve tuning to the X-Y scanner in real time with freely setting the numerical value of each parameter.

The invention described in Claim 3 is the method of drawing vector-oriented graphic for laser projector of any of claim 1 and claim 2, wherein the above-mentioned delay time includes a delay time occurred between when the command is seen by the X-Y scanner and when the mirror of the X-Y scanner actually moves into position specified by the command.

The invention described in Claim 4 is the method of drawing vector-oriented graphic for laser projector of claim 3, wherein the above-mentioned delay time T is calculated by using the equation (a).

$$T = \frac{D}{v} \qquad ( a )$$

T: the time assigned for the beam to move from the start point to the end point of a vector.
D: the length of the vector-data.
v: the velocity the beam has to move.

The invention described in Claim 5 is the method of drawing vector-oriented graphic for laser projector of claim 4, wherein FPS, which is the update rate for each frame drawing in frame per second, is calculated by using the equation (b).

$$FPS = \frac{1}{{T}_{total}} \qquad ( b )$$

F P S: the update rate for each frame drawing in frame per second.
Tₜₒₜₐₗ: the total of the delay time for one frame calculated for each vector-data according to equation (a).

The invention described in Claim 6 is the method of drawing vector-oriented graphic for laser projector of any of claim 1 and claim 2, wherein the above-mentioned blanking time includes a delay time occurred between when the command for switching off/on the laser for blanked line segments is issued and when the laser source actually moves into switching off/on specified by the command.

The invention described in Claim 7 is the method of drawing vector-oriented graphic for laser projector of claim 2, wherein the above-mentioned scanning angle A is calculated by using the equation (c).

$$tan ( \frac{A}{2} ) = \frac{W / 2}{D} \qquad ( c )$$

A: scanning angle in degrees, peak-to-peak.
D: the throw distance from the scanner to the screen.
W: the projected image.

The invention described in Claim 8 is a software of drawing vector-oriented graphic for laser projector, which draws vector-oriented graphic by scanning laser beam with the X-Y scanner, wherein a method to tune scanning speed, delay time, and blanking time is included, comprising: achieving the method of any of claim 1-7.

The invention described in Claim 9 is the software of drawing vector-oriented graphic for laser projector of claim 8, wherein parameters of the scanning speed, the scanning angle, the delay time, and the blanking time are included in input interface of the software to achieve the tuning to the X-Y scanner in real time with freely setting the numerical value of each parameter.

The invention described in Claim-10 is a laser projector system, which draws vector-oriented graphic by scanning laser beam with the X-Y scanner, comprising: a laser source for projecting laser beam; a galvanometer scanner for scanning laser beam with the X-Y mirror to freely control the direction of laser beam; a scanner amp for controlling projection output of laser beam; a scanner controller for controlling the galvanometer scanner and the scanner amp; and a computer connected to the scanner controller, wherein the software of any of claim 8-9 is installed and executed in the computer, and parameters of the scanning speed, the scanning angle, the delay time, and the blanking time are included in input interface of the software to achieve the tuning to the X-Y scanner in real time with freely setting the numerical value of each parameter.

### EFFECT OF THE INVENTION

The invention described in claim 1 produces the effect of correctly drawing vector-oriented graphic for any laser projector with different hardware characteristic (for instance, scanning speed, and blanking time), without hardware tuning, which involves many steps in which we need to alter variable resistances or jumpers on the circuit board.

That is, the invention provides the method of easily tuning the scanning speed, the delay time, and the blanking time to correctly draw vector-oriented graphic for any laser projector.

The invention described in claim 2 produces the effect of correctly drawing vector-oriented graphic for any laser projector, with different hardware characteristic, without hardware tuning, and tuning to the scanner in real time. That is, the invention provides the method of freely setting the numerical value of each parameter (for instance, scanning speed, scanning angle, delay time, and blanking time).

The invention described in claim 3 produces the effect of correctly drawing vector-oriented graphic for any laser projector, with different hardware characteristic, without hardware tuning.

That is, the invention provides the method of easily tuning the delay time, which includes a delay time occurred between when the command is seen by the X-Y scanner and when the mirror of the X-Y scanner actually moves into position specified by the command.

The invention described in claim 4 produces the effect of correctly drawing vector-oriented graphic for any laser projector, with different hardware characteristic, without hardware tuning.

That is, the invention provides the method of easily tuning the delay time, which is calculated by using the equation (a). Also, the invention enables to draw vector-oriented graphic with same brightness in different speeds by changing parameter v.

The invention described in claim 5 produces the effect of correctly drawing vector-oriented graphic for any laser projector, with different hardware characteristic, without hardware tuning.

That is, the invention provides the method of easily tuning FPS, which is calculated by using the equation (b). FPS shows the update rate for each frame drawing in frame per second, and can be controlled by changing parameter v.

The invention described in claim 6 produces the effect of correctly drawing vector-oriented graphic for any laser projector, with different hardware characteristic, without hardware tuning.

That is, the invention provides the method of easily tuning the blanking time, which includes a delay time occurred between when the command for switching off/on the laser for blanked line segments is issued and when the laser source actually moves into switching off/on specified by the command.

The invention described in claim 7 produces the effect of correctly drawing vector-oriented graphic for any laser projector, with different hardware characteristic, without hardware tuning.

That is, the invention provides the method of easily tuning the scanning angle, which shows measurement to decide the size of the projected images, and is calculated by using the equation (C). The scanning angle shows measurement to decide the size of the projected images. Changing parameter A can control the size of the projected images.

The invention described in claim 8 produces the effect of correctly drawing vector-oriented graphic for any laser projector with different hardware characteristic (for instance, scanning speed, and blanking time), without hardware tuning, which involves many steps in which we need to alter variable resistances or jumpers on the circuit board.

That is, the invention provides the software of easily tuning the scanning speed, the delay time, and the blanking time to correctly draw vector-oriented graphic for any laser projector.

The invention described in claim 9 produces the effect of correctly drawing vector-oriented graphic for any laser projector, with different hardware characteristic, without hardware tuning, and tuning to the scanner in real time.

That is, the invention provides the software of freely setting the numerical value of each parameter (for instance, scanning speed, scanning angle, delay time, and blanking time).

The invention described in claim 10 produces the effect of correctly drawing vector-oriented graphic for any laser projector with different hardware characteristic (for instance, scanning speed, and blanking time), without hardware tuning, which involves many steps in which we need to alter variable resistances or jumpers on the circuit board.

That is, the invention provides the system of easily tuning the scanning speed, the delay time, and the blanking time to correctly draw vector-oriented graphic for any laser projector. Also, the invention provides the system of freely setting the numerical value of each parameter (for instance, scanning speed, scanning angle, delay time, and blanking time).

### BRIEF DESCRIPTION OF DRAWINGS

FIG. 1 shows four different laser projection of the peace dove.

FIG. 2 is a block diagram showing the construction of the prototype of laser projector system.

FIG. 3 shows the scan angle and the distance to the screen determines the width of the projected image.

FIG. 4 shows before and after applying intensity normalization.

FIG. 5 shows example of D to A vs. Sync Delay.

FIG. 6 shows example of D to A vs. Sync Delay where the two are synchronized.

FIG. 7 shows blanking test pattern (1).

FIG. 8 shows blanking test pattern (2).

FIG. 9 shows ILDA test pattern.

FIG. 10 shows blanking speed and damping.

FIG. 11 shows tuning by compensating the total latency delay.

FIG. 12 shows tuning by controlling the velocity.

FIG. 13 shows scan angle vs. velocity.

FIG. 14 shows velocity vs. scan rate for only correct projection of ILDA pattern.

FIG. 15 shows velocity vs. scan rate for ILDA test at 8° for all cases including distorted projection.

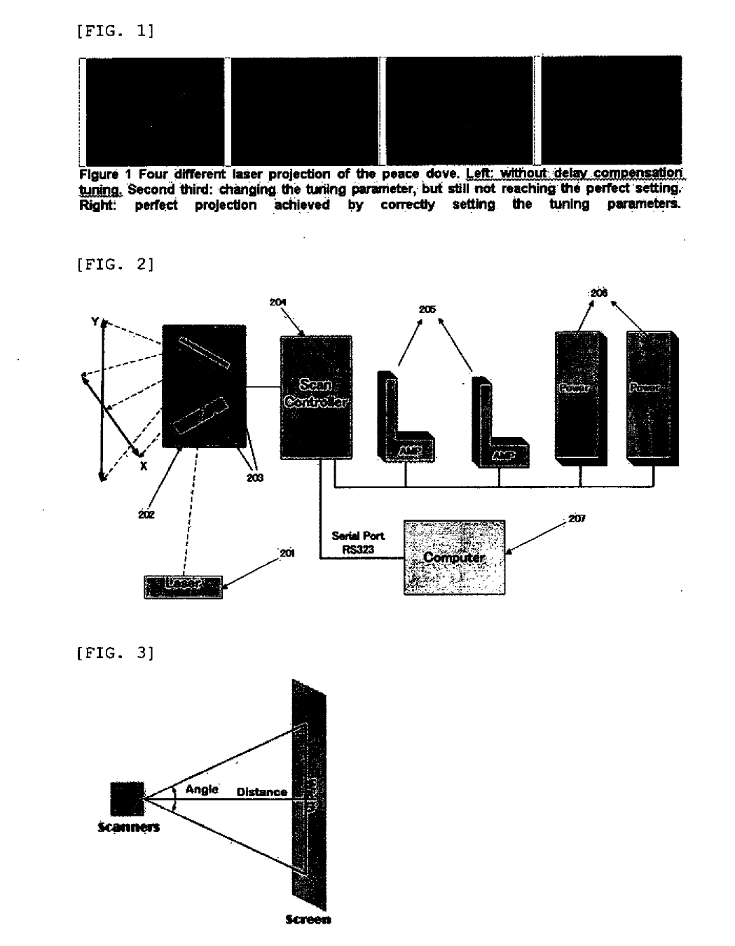

### EXPLANATION OF CODES USED IN THE DRAWINGS

201 Laser Source
202 Galvanometer Scanner
203 X-Y Mirrors
204 Scanner Controller
205 Scanner Amplifiers
206 Power
207 Computer

### DETAILED DESCRIPTION OF THE INVENTION

### Best Mode for Carrying Out the Invention

Next, based on the diagrams, a prototype of laser projector system of this invention is described. However, the invention is not limited to this prototype.

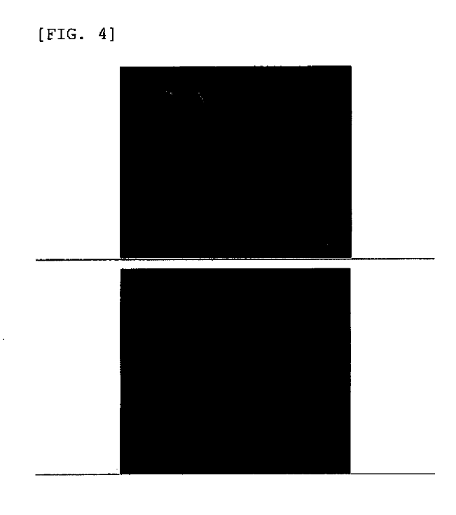

FIG. 2 is a block diagram showing the construction of the prototype of laser projector system.

The laser projector system draws vector-oriented graphic by scanning laser beam with the X-Y scanner, and comprises: a laser source 201 for projecting laser beam; a galvanometer scanner 202 for scanning laser beam with the X-Y mirror 203 to freely control the direction of laser beam; a scanner amp 205 for controlling projection output of laser beam; a scanner controller 204 for controlling the galvanometer scanner and the scanner amp; and a computer 207 connected to the scanner controller 204.

Here, the software is installed and executed in the computer 207, and parameters of the scanning speed, the scanning angle, the delay time, and the blanking time are included in input interface of the software to achieve the tuning to the X-Y scanner in real time with freely setting the numerical value of each parameter.

The laser projector is the heart of a graphics system. It contains the galvanometer scanners and scanner amplifiers, which together move the beam fast enough to create graphics. The laser beam first encounters the X (horizontal) scanner. This deflects the beam at right angles to its line of travel and upwards onto the Y mirror. The Y mirror takes the line drawn by the X mirror and moves it vertically. Using an X-Y scanning system fed from analogue oscillator circuits, the position of the beam can be controlled so as to allow for the projection of complex abstracts. With digitizing and storing images in a computer, complex graphics and animations can be projected. The projector also contains an intensity device that blanks and/or colors the beam. There can be other parts, such as beam tables and lamina special effect devices.

The basic components of our laser projection system consist of the following.

Scan controller: It is responsible for communicating with PC and axis servos, and it has memory to store programs before sending them to the scanner amp.

Scanner amp: It converts the digital signals from the main controller into analog currents for the galvanometers and also communicates the position feedback to the scan controller. Each closed-loop galvo scanner requires a closed-loop scanner amplifier, to condition and amplify the computer's laser control signals. We need two of these to run X-Y scanners.

Galvanometer scanners: It is also called galvo scanners. These are scanners to move tiny mirrors that deflect the beam. There two mirrors one for the horizontal motion (X) and one for the vertical motion (Y). Together, they can position the beam anywhere on the display screen.

Laser beam: A laser beam of a given color and intensity.

Power: supply power to laser projector.

The projector used in our experiments was built using the following components [8] [9]:

Scan Controller: GSI Lumonics SC2000.

Servo Controllers (scan amps): GSI Lumonics MiniSAX (2 units).

Galvanometers scanners: GSI Lumonics VM-500

Laser: Coherent MVP Control Diode Laser Module. Wavelength: 670 nm (Red). Power: 0.95 mW.

### (1) LASER SCANNER CHARACTERIZATION

### (1.1) Scan Rate

One of the most used terms in the discussion of scanner performance is ‘30K’, which is shorthand for 30,000 points per second [PPS] (30K pps). Laser computer systems generate laser graphics by outputting XY data points sequentially. This data is used to move the scanners in the horizontal and vertical (X&Y) axis to draw laser graphics. The laser spot traces the path of these points very quickly. These points are blurred into lines in the eye of the viewer. The rate at which these data points are output is defined as ‘points per second’ or ‘pps’ 30K therefore indicates an output rate of 30,000 points per second from the computer (or other signal source). Other terms used to describe the rate at which points are output include ‘scanning speed’ scan rate' and ‘point rate’.

Some systems do not provide the scan rate in points per second. This is unfortunate, because you need to know how fast you're running. This parameter is specifically related to laser projection system and must be considered carefully when creating graphics to avoid flickering. We need to know the maximum speed of the scanners when digitizing the graphics to avoid flickering or driving the scanners beyond its capabilities. PPS can be calculated from Equation (1):

PPS=NOP×FPS (1)

[PPS] is the scan rate in points per seconds, [NOP] is the number of points in one frame drawing, and [FPS] is frame per second that one frame should be repeated to give the illusion of continuity to the eye.

### (1.2) Scan Angle

The scan angle is a measurement to decide the size of the projected images. The optical scan angle is determined by the size of the projected image and the distance between the image and the scanners as illustrated in FIG. 3. The mechanical scan angle, in contrast, is the excursion angle of a single scanner, or one-half the optical scan angle. Formula (2) can be used to determine the scan angle:

$$tan ( \frac{A}{2} ) = \frac{W / 2}{D} \qquad ( 2 )$$

Here A is the scanning angle in degrees. D is the throw distance from the scanners to the screen, and W is the projected image.

### (2) INTENSITY NORMALIZATION

A laser projection inherent problem is related to the strong link between the drawing speed of each line segment and the resulted projection intensity. If two lines of different length are drawn with the same interval, the shorter line will look brighter than the longer one, because to draw longer line in same time interval the mirrors have to move faster than when drawing shorter one. The slower the mirrors move the brighter (more intense) the laser beam line will look. This problem can be solved by either moving the laser beam with a constant velocity for all vectors by adjusting the beam intensity according to the lengths of the vectors, or by applying constant laser beam intensity and adjust the motion speed according to the distance the laser has to travel from one point to another.

The general technique to achieve the same brightness for vectors with different lengths is by calculating the time delay between movements according to the length of the vectors (lines). Here we are going to call it “intensity normalization technique”.

A new velocity concept has been adopted to achieve stable intensity without the need to process all the frame data. First, we will explain the classical method for intensity normalization then we describe our method.

### (2.1) Total Frame Length

In this approach we need first to have the whole data for the frame to be drawn before we can apply the Equation (3):

$$VectorTimeDelay = \frac{VectorLength}{TotalFrameLength \times FPS} \qquad ( 3 )$$

Where “VectorTimeDelay” is the drawing time delay in time units for a given Vector, and VectorLength is its length in distance units. ‘Total Frame Length’ is the sum of the lengths of all the vectors for this frame, and ‘ FPS’ is the desired update rate in frames per second.

The draw back of this approach is the need to process the whole data of the drawing before you can assign the suitable time for each line so it is not suitable for real time processing and analyzing.

### (2.2) Velocity Concept

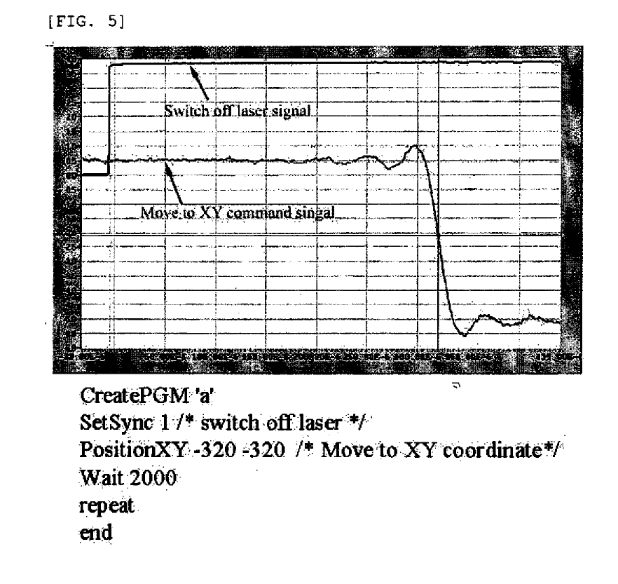

A velocity parameter, which describes the motion speed of the laser beam, has been used to control the laser drawing program and assign the suitable time to each beam movement. In this approach there is no need to wait until you process all the data, you can calculate the suitable time for each line on fly using the velocity Equation (4):

$$t = \frac{D}{v} \qquad ( 4 )$$

Where t is the time assigned to the beam to move from the start point to the end point of each vector, D is the length of the vector, and v is the velocity the beam has to move. D can be calculated on fly after generating each vector and by changing v we can draw graphics in different speeds with same brightness. FIG. 4 illustrates the two projected images (a) before applying intensity normalization, and (b) after applying intensity normalization.

The velocity v can control the FPS for each drawing considering the following Equation (5).

$$FPS = \frac{1}{T} \qquad ( 5 )$$

Where FPS is the update rate for each frame drawing in frame per second, and T is the total time delay for one frame calculated for each vector data according to Equation (4). The velocity we can control the FPS and the scan rate as well through t in Equation (4).

### (3) BLANKING AND SYNCHRONIZATION DELAY CONCEPT

Blanking is the technique of turning the laser beam on and off with precise control. For scanned graphics blanking allows images to have disconnected sections where the beam is hidden. Blanking can be digital (on/off) or analog (continuous intensity control). Blanking can be performed with a third scanner, an acousto-optic modulator (AOM), or by electronically controlling the laser output as done with semiconductor lasers. The later technique has been used in our experimental laser projector. Applying blanking could be a critical issue that could lead to unexpected result to the projected image. This is meanly because of the delay between issuing a command to move the mirrors and the time that actually the mirrors has moved or stopped. This time delay should be considered carefully to achieve correct projection with blanking, which leads us to the system latency that would be explained in the next section.

### (3.1) System Latency Issue

The Scan Controller is intended to provide low jitter delivery of an output waveform, with predictable timing. Delays of the same order as the fixed delay through the galvo scanners are encountered and must be taken into account.

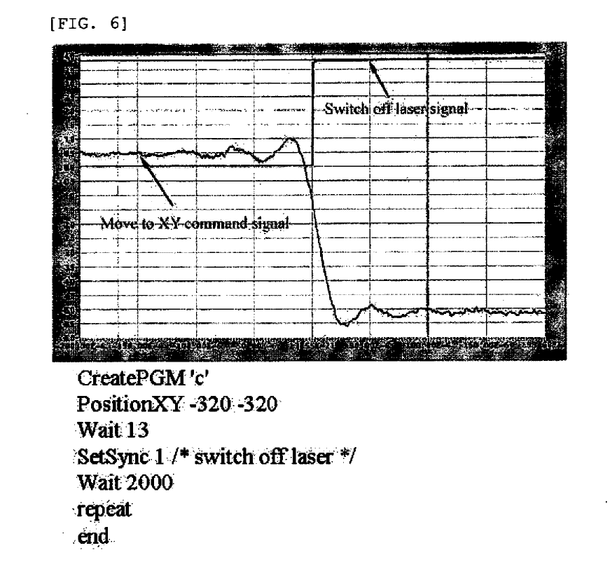

The most significant delays occur between the time when an instruction is evaluated, and when an actual voltage value emerges from the output of DAC (Digital Analog Converter). This delay is due to a number of factors, dominated by the anti-imaging filters in the DAC. Compared with this, other delays, for instance between when an instruction is evaluated and when a Sync pin changes state, are almost negligible. To show this delay a simple program ‘a’ listing is shown below the FIG. 5 from which we can observe that this delay between SetSync command to switch off the laser and the positionXY −320 −320 command (move laser beam to x, y position) is about 315 μs. The laser has been switched off before the laser beam start moving as both command not synchronized. FIG. 6 shows the system behavior in response to program ‘c’, whose listing is also follows the FIG. By inserting a wait 12 command that delaying the SetSync relative to the PositionXY command, the two are synchronized.

The laser controller includes commands tailored to handle the latency inherent in the scanners and positioning galvos. These commands fall under the category of side effect commands are named DelayedSetSync and DelayedUnsetSyns. The action of these commands is similar to Setsync and Unsetsync in that they control the state of the sync output channels; except that the electrical output action of the command is postponed some number of tick counts from time of executions in the motion control program. These adjustable delays can take care of the real-world latencies of the positioning system at run-time. There will be further critical delay that is difficult to be estimated easily between when the command is seen by the x-y scanners and when the mirror has actually moved into position • each projection system needs to be evaluated to estimate the total delays to be able to compensate these delays, which we call it the (system latency) to have correct command timing. The next section explains an experiment carried out to exactly estimate and compensate the total system latency.

### (3.2) Blanking Experiment

As has been stated in the previous section, command timing (synchronization) is very important to have correct laser projection as various latencies in the hardware must be taken into consideration. The most important case is the timing between switching off/on the laser beam and when the mirrors have actually stopped.

The main purpose of this experiment is to set up a test that enables us to measure the system latency and compensate it • we call this procedure tuning. It could be a difficult task, as we do not know exactly the time delay value that should be compensated as explained before. Therefore, a simple test pattern has been proposed to estimate the proper delay.

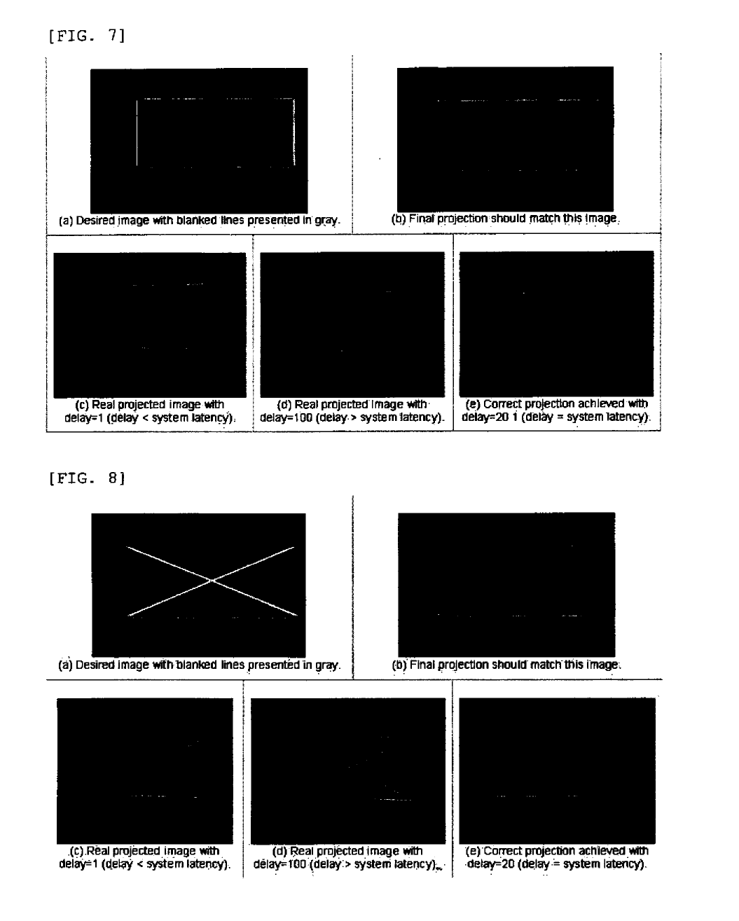

Projecting parallel lines is a fundamental test for laser projector as command timing for blanking is crucial to get correct presentation. To make the result more general we tested two patterns of parallel lines as can be seen in FIG. 7(a) and FIG. 8(a), where blanked lines could be set vertically or diagonally.

The tested parameter in this experiment is the delay that has to be compensated between moving command positionXY and the commands to switch off and on the laser for the blanked line segments. This delay has to be equal to the total system latency to get perfect commands synchronization. Therefore, we tuned this delay until we could get a perfect two parallel lines, the delay was equals to 20 ticks count (time unit) FIG. 7(e). This time unit depends on the system clock and it differs from projection system to another, therefore, such tuning is important. In our system one tick (time unit) is 23 μs. If the delay is not equal to the system latency we could get unexpected results. In case of switching the laser off very fast before the scanner deliver the right voltage to the galvo and before the mirrors finish previous movement (delay<system latency) then we get the results like the one in FIG. 7 (c) where the delay was set to 1 time units (23 μs). If the delay is longer than the total latency of the system then we could get the result in FIG. 7 (d) where the delay was set to 100 time units (2300 μs).

The same discussion could be applied to FIG. 8 where the blanked lines were set diagonally. Different time delay compensation could lead to different results. The most noticeable result is that we could achieve correct projection for the two test patterns with exactly the same delay (20 time units), which mean that for our laser projector the system latency is 460 μs that has to be compensated to get commands synchronized perfectly. Although the test is simple, but it can evaluate the system latency in any laser projection efficiently. This will be further verified in section 4 when describing experimental results.

### (4) ILDA TEST PATTERN

To verify the result of the proposed test and the delay we used ILDA test pattern. The test pattern's primary use is in alignment and calibration of galvanometer based laser vector graphic projection systems, but we used it merely to verify the obtained result from the proposed simple test patterns and to characterize our laser projector performance by exploring the relation ship between the scan rate, scan angle, and velocity.

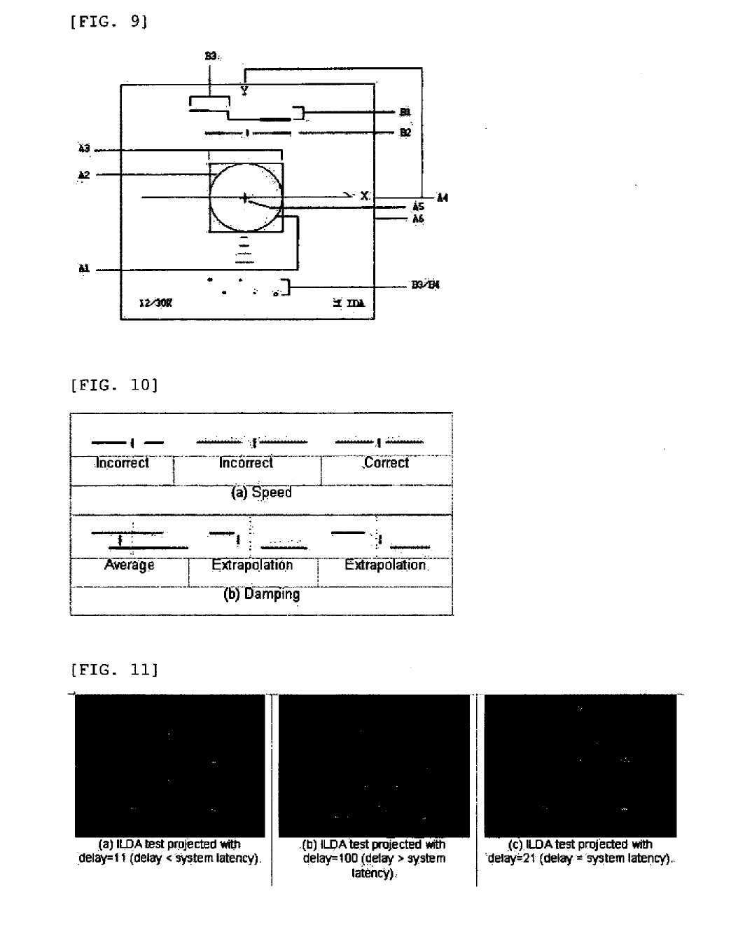

The original ILDA standard test pattern [6] can be seen in FIG. 9. We will explain only the most important factors of this test that concern our experimental system for we are not concern in ILDA tuning procedure as we use this pattern merely as a data that every one on the laser committee has agreed on how it should looks for different scan rates. A1: Scanner Speed. The circle should be the same size (width and height) as the square. It should touch the midpoint of each side of the square. If scanning systems were perfect, then the circle would be larger than the square • the way it was digitized. But since the scanners don't have a perfect response the standard is arbitrarily set to have the circle be the same size as the square. B1 is the Blanking Speed. The upper and lower horizontal lines should meet at the small vertical line, FIG. 10 (a). B2 is the Blanking Damping. The two horizontal lines should be equally spaced from the small vertical line, FIG. 10 (b).

### (4.1) Tuning Results

During our tests we only adjusted the parameters inside the program and we did not apply any hardware tuning as we wanted to set a general testing procedure for any laser and be able to determine the speed from those tests.

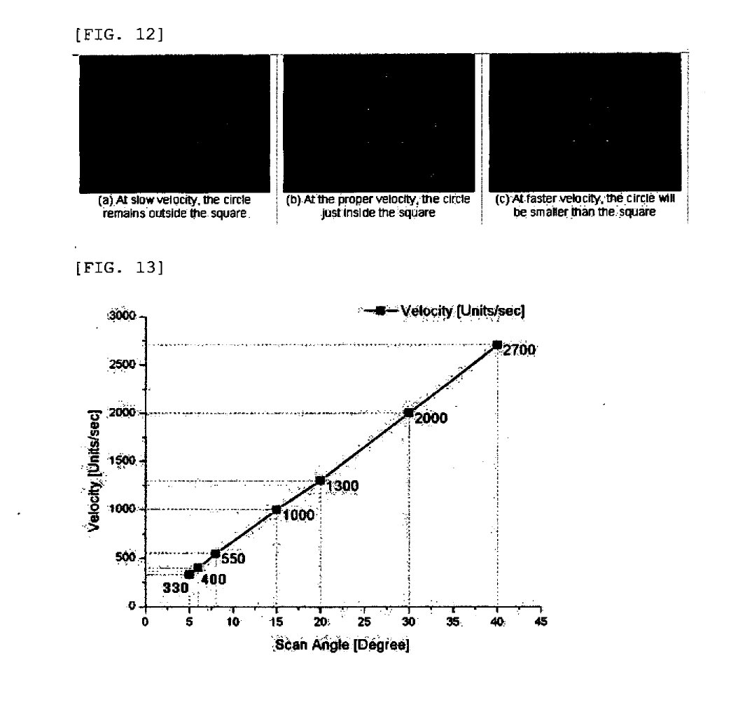

The first result is that we could display all the part of ILDA 30K test pattern correctly as recommend by ILDA association even though the scanners were tuned to unknown test pattern. This has been achieved by controlling the velocity parameter, and the total delay (system latency) of the laser projector. Without the need to adjust the scanner and the controller we could display the ILDA test correctly by just adjusting these 2 parameters inside our program. FIG. 11 represents the results of three different projection of ILDA test pattern for different delays (total system latency). FIG. 12 shows how by controlling the velocity we could control the scanning speed from slow to fast.

The important noticeable result of the experiment is that we could not get B1 (Blanking Speed) and B2 (Blanking Damping) correctly projected until we carried out many adjustments to the latency delay, the most interesting result is that the required compensation latency to get the test projected correctly was 20 time units, which is exactly the same time obtained from the previously proposed parallel test patterns. This supports our discussion about the efficiency of the proposed test, which means that by using the simple test patterns proposed in section 5.2 we can decide quickly the total delay for any laser projection system that has to be compensated to get commands synchronized perfectly.

### (5) LASER SCANNER PERFORMANCE

Using the velocity concept we carried out many experiment to specify the relation ship between scan rate, scan angle, and velocity, also to define the scanner performance. The scan angle is a measurement to decide the size of the projected images as described previously. The bigger the size the more distance the laser beam has to travel, which lead to more delay needed to preserve the projection quality of the projected images. The final image quality will be decided by Equation (1) as FPS and the number of points in each frame is affecting the scan rate directly.

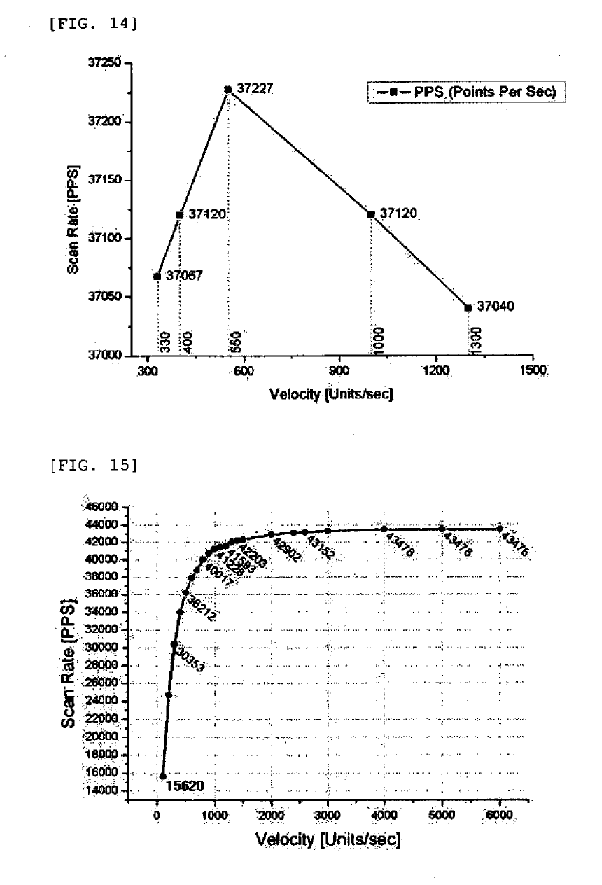

FIG. 13 shows that the relation between velocity and scan angle is linear. Therefore, to project larger graphics we need to increase the velocity which in turn means more scanning speed is required. There is a limit on how fast you can go or how large you can scale up the projection. This is all depends on the scanner speed. We could project the ILDA pattern correctly up to 20° (velocity 1300) where after that the inside circle became ellipse and the quality of the image started to distort little by little as the scan angle increased. This means that we drove the laser projector to its limits and cannot project faster than this rate. We calculated the scan rate for the correctly projected images of ILDA pattern as shown in FIG. 14. The best result was obtained at velocity equal to 550, which mean that the scan rate is 37227 PPS. Nevertheless, FIG. 14 concludes clearly that the scan rate for our laser system is around 37000 PPS. We call this speed the practical scanning speed. The manufacture usually gives the ideal speed, for example, it was 43000 PPS for our scanners. Therefore, it is recommended not to drive the scanner beyond the practical limit to avoid damaging them.

To confirm the ideal speed of the scanner we calculated the scan rate for different velocities with scan angle fixed to 8° and the result is shown in FIG. 15. As a result, the ideal speed was 43478 PPS. This is confirming the speed of the scanners mentioned in the catalog, which is 43000 PPS.

### (6) CONCLUSION

Lasers are the most powerful light source on the earth. Animated laser graphics, communicates exciting messages using a medium more eye-catching than conventional slides or video.

Laser graphics has not yet been explored and researched extensively. Mostly, the industry is developing their own techniques and algorithms to project graphics. We believe that there could be a place for researchers from different fields to have their contribution into the hardware side and computer graphics side to achieve more effective and efficient projection of complex graphics and apply it to new applications. In this paper we established the basic knowledge to deal with a laser projector system and put forward the equations to describe each specific parameter of a laser projector. Mainly, we present a general approach to be able to project graphics correctly no matter what test pattern the scanners originally tuned to. This is achieved by describing what you should consider when you prepare you vector data and how to set the delay for each vector and how to decide the blanking timing for the scanners in use. Also, a simple test to measure a laser projector performance has been explained. In addition, a new velocity concept to control the drawing speed of the projector has been described. Finally, we showed the relation between scan angle, scan rate, and velocity from which we could conclude experimentally the performance of the laser projector. In conclusion, we can say that the application for laser vector display are wide and excited, the main limitation is the scanners speed, but as we continue to get faster scanners to work with, the graphics will become more complex and a new application can be thought of to fully utilize this technology.

### INDUSTRIAL APPLICABILITY

Laser projection has been around for a while where it finds its way into entertainment community, especially live music concert where laser show becomes an essential part. Recently, projecting complex graphics imagery becomes possible with ever-fast scanners providing enough speed.

The present invention provides technologies for correctly drawing vector-oriented graphic for any laser projector with different hardware characteristic (for instance, scanning speed, blanking time), without hardware tuning, which involves many steps in which we need to alter variable resistances or jumpers on the circuit board. That is, the invention provides the method of easily tuning the scanning speed, the delay time, and the blanking time to correctly draw vector-oriented graphic for any laser projector.

1-10. (canceled)

11. A method of drawing vector-oriented graphic for laser projector, which draws vector-oriented graphic by scanning laser beam with the X-Y scanner, wherein a method to tune scanning speed, delay time, and blanking time is included, comprising: transmitting one vector-data, for drawing vector-oriented graphic, to a X-Y scanner one by one; controlling the scanning speed of each vector-data; calculating the delay time and the blanking time corresponding to the scanning speed of each vector-data; deciding appropriate timing to compensate the above-mentioned delay time when the command for transmitting vector-data is issued; and deciding appropriate timing to compensate the above-mentioned blanking time when the command for switching off/on the laser for blanked line segments is issued.

12. The method of drawing vector-oriented graphic for laser projector of claim 11, wherein parameters of the scanning speed, the scanning angle, the delay time, and the blanking time are included to achieve tuning to the X-Y scanner in real time with freely setting the numerical value of each parameter.

13. The method of drawing vector-oriented graphic for laser projector of claim 11, wherein the above-mentioned delay time includes a delay time occurred between when the command is seen by the X-Y scanner and when the mirror of the X-Y scanner actually moves into position specified by the command.

14. The method of drawing vector-oriented graphic for laser projector of claim 13, wherein the above-mentioned delay time T is calculated by using the equation (a).
$$T = \frac{D}{v} \qquad ( a )$$
T: the time assigned for the beam to move from the start point to the end point of a vector.
D: the length of the vector-data.
V: the velocity the beam has to move.

15. The method of drawing vector-oriented graphic for laser projector of claim 14, wherein FPS, which is the update rate for each frame drawing in frame per second, is calculated by using the equation (b).
$$FPS = \frac{1}{{T}_{total}} \qquad ( b )$$
FPS: the update rate for each frame drawing in frame per second.
Tₜₒₜₐₗ: the total of the delay time for one frame calculated for each vector-data according to equation (a).

16. The method of drawing vector-oriented graphic for laser projector of claim 11, wherein the above-mentioned blanking time includes a delay time occurred between when the command for switching off/on the laser for blanked line segments is issued and when the laser source actually moves into switching off/on specified by the command.

17. The method of drawing vector-oriented graphic for laser projector of claim 12, wherein the above-mentioned scanning angle A is calculated by using the equation (c).
$$tan ( \frac{A}{2} ) = \frac{W / 2}{D} \qquad ( c )$$
A: scanning angle in degrees, peak-to-peak.
D: the throw distance from the scanner to the screen.
W: the projected image.

18. A software of drawing vector-oriented graphic for laser projector, which draws vector-oriented graphic by scanning laser beam with the X-Y scanner, wherein a method to tune scanning speed, delay time, and blanking time is included, comprising:
achieving the method of claim 11.

19. The software of drawing vector-oriented graphic for laser projector of claim 18, wherein parameters of the scanning speed, the scanning angle, the delay time, and the blanking time are included in input interface of the software to achieve the tuning to the X-Y scanner in real time with freely setting the numerical value of each parameter.

20. A laser projector system, which draws vector-oriented graphic by scanning laser beam with the X-Y scanner, comprising:
a laser source for projecting laser beam; a galvanometer scanner for scanning laser beam with the X-Y mirror to freely control the direction of laser beam; a scanner amp for controlling projection output of laser beam; a scanner controller for controlling the galvanometer scanner and the scanner amp; and a computer connected to the scanner controller, wherein the software of claim 18 is installed and executed in the computer, and parameters of the scanning speed, the scanning angle, the delay time, and the blanking time are included in input interface of the software to achieve the tuning to the X-Y scanner in real time with freely setting the numerical value of each parameter.

21. The method of drawing vector-oriented graphic for laser projector of claim 12, wherein the above-mentioned delay time includes a delay time occurred between when the command is seen by the X-Y scanner and when the mirror of the X-Y scanner actually moves into position specified by the command.

22. The method of drawing vector-oriented graphic for laser projector of claim 12, wherein the above-mentioned blanking time includes a delay time occurred between when the command for switching off/on the laser for blanked line segments is issued and when the laser source actually moves into switching off/on specified by the command.

23. A software of drawing vector-oriented graphic for laser projector, which draws vector-oriented graphic by scanning laser beam with the X-Y scanner, wherein a method to tune scanning speed, delay time, and blanking time is included, comprising: achieving the method of claim 12.

24. A software of drawing vector-oriented graphic for laser projector, which draws vector-oriented graphic by scanning laser beam with the X-Y scanner, wherein a method to tune scanning speed, delay time, and blanking time is included, comprising: achieving the method of claim 13.

25. A software of drawing vector-oriented graphic for laser projector, which draws vector-oriented graphic by scanning laser beam with the X-Y scanner, wherein a method to tune scanning speed, delay time, and blanking time is included, comprising:
achieving the method of claim 14.

26. A software of drawing vector-oriented graphic for laser projector, which draws vector-oriented graphic by scanning laser beam with the X-Y scanner, wherein a method to tune scanning speed, delay time, and blanking time is included, comprising: achieving the method of claim 15.

27. A software of drawing vector-oriented graphic for laser projector, which draws vector-oriented graphic by scanning laser beam with the X-Y scanner, wherein a method to tune scanning speed, delay time, and blanking time is included, comprising: achieving the method of claim 16.

28. A software of drawing vector-oriented graphic for laser projector, which draws vector-oriented graphic by scanning laser beam with the X-Y scanner, wherein a method to tune scanning speed, delay time, and blanking time is included, comprising: achieving the method of claim 17.

29. A laser projector system, which draws vector-oriented graphic by scanning laser beam with the X-Y scanner, comprising: a laser source for projecting laser beam; a galvanometer scanner for scanning laser beam with the X-Y mirror to freely control the direction of laser beam; a scanner amp for controlling projection output of laser beam; a scanner controller for controlling the galvanometer scanner and the scanner amp; and a computer connected to the scanner controller, wherein the software of claim 19 is installed and executed in the computer, and parameters of the scanning speed, the scanning angle, the delay time, and the blanking time are included in input interface of the software to achieve the tuning to the X-Y scanner in real time with freely setting the numerical value of each parameter.
